(19) United States
(12) Patent Application Publication
(10) Pub. No.: US 2024/0115073 A1
(43) Pub. Date: Apr. 11, 2024

(54) ZONED PELLET GRILL

(71) Applicant: BBQ GUY'S MANUFACTURING, LLC, Baton Rouge, LA (US)

(72) Inventors: Richard STEWART, Baton Rouge, LA (US); Brian CANOVA, Baton Rouge, LA (US)

(73) Assignee: BBQ GUY'S MANUFACTURING, LLC, Baton Rouge, LA (US)

(21) Appl. No.: 18/377,549

(22) Filed: Oct. 6, 2023

Related U.S. Application Data
(60) Provisional application No. 63/413,674, filed on Oct. 6, 2022.

(51) Int. Cl. A47J 37/07; A47J 36/32; A47J 37/04; F24B 5/06; F24B 13/02; F24B 13/04

(52) U.S. Cl. CPC A47J 37/0704; A47J 36/321; A47J 37/041; A47J 37/0754; A47J 37/0786; F24B 5/06; F24B 13/02; F24B 13/04

(57) ABSTRACT

The invention is a multi-firepot pellet grill that provides zoned cooking. The design incorporates two or more heat sources, strategically positioned within the cooking chamber, to provide consistent and even heat distribution, enabling a wider variety of cooking techniques, including zone cooking. In one or more embodiments, the invention incorporates a PID (Proportional-Integral-Derivative) controller with or without altitude compensation technology to maintain precise temperature control.

### CROSS-REFERENCE TO RELATED APPLICATIONS

This application claims benefit of priority under 35 U.S.C. § 119(e) of U.S. Ser. No. 63/413,674, filed Oct. 6, 2022, the entire contents of which is incorporated herein by reference in its entirety.

### STATEMENT REGARDING FEDERALLY SPONSORED RESEARCH OR DEVELOPMENT

Not Applicable.

### BACKGROUND OF THE INVENTION

### Field of the Invention

This invention relates to the field of food preparation devices. Specifically, it relates to grilling, smoking, and rotisserie cooking. It especially relates to the field of pellet grill cooking devices and methods of using the same.

### Background Information

Pellet grills (sometimes referred to as pellet cookers, pellet smokers, or pellet-smoker-grills) offer the flavor of wood-fired cooking with the ease of a gas grill. Pellet grills are capable of low-and-slow cooking as well as high grilling temperatures, although pellet grills to date suffer uneven cooking at high temperatures. Thus, they are versatile, easy to use, and have a wide range of cooking temperatures. Pellet grills typically comprise a hopper that holds pellets which are generally hardwood pellets. The user loads the pellets in the hopper and sets the temperature for the grill and heat generated from burning the pellets cooks the food. Many users are drawn to the versatility of pellet grills. They may be used to grill, bake, roast, or smoke food. This is because most pellet grills provide a stable cooking temperature through heat and smoke control by monitoring the temperature inside the grilling device and adjusting the feed rate of pellets to match, increase, or decrease the temperature therein. Whereas traditional charcoal grills provide smokey flavor, the temperature on a charcoal grill is much more difficult to regulate.

Accordingly, pellet grills typically comprise a hopper to hold the pellets, a fan to distribute the heat and smoke, a firebox, and an electronic control. Pellet grills may also comprise an auger or other device the moves the pellets from the hopper to a firebox and/or fire pot in which the pellets may be combusted or smolder. For clarity, the firebox generally relates to the chasses of the grill wherein the cooking heat and smoke are derived through combustion by igniting the pellets. The fan or a fan system may be used to assist with the circulation of heat in the cooking chamber. Alternatively, the fan may be used to provide requisite airflow (i.e., oxygen) to the fire pot.

The electronic control maintains pellet consumption and will stoke the fire as necessary to achieve the user's desired heat and/or smoke level. Entry level pet grills may have a controller located on the grill that can be set only to one of the pre-set temperature positions. However, these controllers can have temperature differentials from the set temperature of upwards of 40 degrees. One more advanced form of an electronic control is a proportional-integral-derivative (“PID”) controller. PID controls operated on a control loop mechanism that uses feedback to determine the output. Thus, PID controllers run calculations on a constant basis based on inputs such as fan speed and pellet consumption rate in order to stabilize the temperature of the grill. PID controllers can generally maintain grill temperatures within +/−5 degrees of the user's inputted temperature setting. PID controllers are especially useful for pellet grills with variable-speed fans and augers. Some PID controllers are also equipped with Wi-Fi capabilities and can be paired with an app on a user's smart device. This allows the user the convenience of monitoring from the smart device and adjusting remotely.

Pellet grills may be freestanding or built-in. Freestanding pellet grills allow the user to move the grill around and provide extra space for shelves or other attachments. Portable pellet grills typically run on a 12-volt battery or mobile battery pack. Built-in pellet grills, on the other hand, are designed to be fit into an existing outdoor kitchen or island. Both freestanding and built-in pellet grills are known to be powered via traditional power cables connected to electrical outlets.

One of the primary drawbacks of conventional single-heat-source pellet grills is their inability to provide consistently even heat distribution across the grilling surface. The single heat source, usually located in the center of the grill, generates uneven temperatures throughout the cooking chamber. This disparity in heat can lead to uneven cooking results, where some portions of the food are overcooked, while others remain undercooked. Such inconsistencies can compromise the quality and appeal of the grilled dishes, limiting the grills' ability to deliver consistently satisfying culinary experiences.

Although traditional pellet grills offer versatility and controlled heating, all of the cooking in the grill chamber must be done at the same temperature. Thus, if a user wanted to slow cook bone-in chicken but quickly heat up sausage, she would have to cook the sausage first and then put on the chicken (or vice versa). Instead, it would be beneficial for the user to start the chicken in the morning, add the sausage an hour or two before the chicken is done as an appetizer, and then pull off the chicken. The current invention provides this type of versatility in a pellet grill. More important, the traditional pellet grill is a uni-dimensional, uni-temperature cooking apparatus in that it operates in an “either/or” cooking setup. It is either operating as a smoker oven or it is operating as a grill, but never as a smoker and a grill. Thus, if a user wanted to sear meat while smoking another product or wanted to have a sear zone and then transition the meat to another portion of the grill for lower temperature cooking, the user would have to time and adjust the actions to transition the grill from one set up to another. Such never run concurrently.

Their reliance on a solitary heat source restricts users to relatively straightforward grilling methods, making them less suitable for more complex cooking techniques. The limited heat control options can hinder users from experimenting with various cooking styles, such as searing, smoking, or zone cooking, where different areas of the grill are used for various purposes simultaneously.

Additionally, many prior art pellet grills experience “burn back.” Burn back occurs when although the grill has been turned off, pellets in the auger continue to smolder and/or burn because of residual heat from tubes/slides in the auger. This causes unwanted burning of the pellets and potential fire. Prior art pellet grills often suffer from pellets jammed with the auger. When this happens, the pellets do not make it to the fire box, and it can cause damage to the auger. The user is then required to manually clean out the auger through an arduous process.

### SUMMARY OF INVENTION

The present invention introduces a groundbreaking multi-firepot pellet grill system designed to revolutionize outdoor cooking. This innovative grill system overcomes the limitations of traditional single-heat-source pellet grills, providing enhanced performance, versatility, and precise temperature control.

The multi-firepot pellet grill incorporates at least two strategically positioned heat sources within the cooking chamber. This configuration ensures consistent and even heat distribution across the grilling surface, eliminating common issues of uneven cooking associated with single-heat-source grills.

In one or more embodiments, the grill system is equipped with a sophisticated PID (Proportional-Integral-Derivative) controller. This controller offers precise temperature regulation and maintains the desired cooking temperature with remarkable accuracy. It adjusts the heat sources based on real-time temperature readings, delivering consistently excellent cooking results and has the unique capability of doing this in multiple zones.

In one or more embodiments, the PID controller includes an altitude compensation feature, which takes into account changes in barometric pressure at different altitudes. This innovation ensures that the grill performs optimally regardless of the environmental conditions, making it suitable for use at various elevations.

This multi-firepot design opens up a world of culinary possibilities. Users can employ various cooking techniques, such as searing, smoking, roasting, and zone cooking, simultaneously or individually. This versatility allows for the preparation of diverse dishes with precision and creativity.

### BRIEF DESCRIPTION OF THE DRAWINGS

The drawings constitute a part of this specification and include exemplary embodiments of the Zoned Pellet Grill, which may be embodied in various forms. It is to be understood that in some instances, various aspects of the invention may be shown exaggerated or enlarged to facilitate an understanding of the invention. Therefore, the drawings may not be to scale

FIG. 1 shows an embodiment of the pellet grill wherein the hood is opened and the grates are exposed.

FIG. 2A shows an embodiment of the grill with three separate cooking chambers with the front wall cutaway.

FIG. 2B shows an embodiment of the grill with three separate cooking chambers for the top with the grate removed.

FIG. 2C shows an embodiment of the grill with three separate cooking chambers with one fire pot exposed.

FIG. 3 shows a side view of the pellet grill.

FIG. 4 shows a front view of the pellet grill.

FIG. 5A shows the dual auger and fan systems with self feeding hopper.

FIG. 5B shows another embodiment of the dual ager and fan system and ventilation holes.

FIG. 6 shows the angled auger.

FIG. 7 shows an open view of the pellet grill depicting the open hopper and feed system.

FIG. 8A is an open view showing the grease trap system

FIG. 8B is an open view showing the fire pot and pellet feed system.

FIG. 9 shows one side of the grill with the grate removed to show one of the diverters.

FIG. 10 is an embodiment of one of the diverters.

FIG. 11 shows one of the diverters and fire pots.

FIG. 12 is a front view of the fire pot placement of the diverters depicting heat and air flow through the cooking chamber.

FIG. 13 shows one embodiment of a fire pot with a tab for removal.

FIG. 14 shows an embodiment of the grill with a rotisserie spit.

FIG. 15 is a schematic of one possible on-grill, app control logic.

### DETAILED DESCRIPTION OF THE INVENTION

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies.

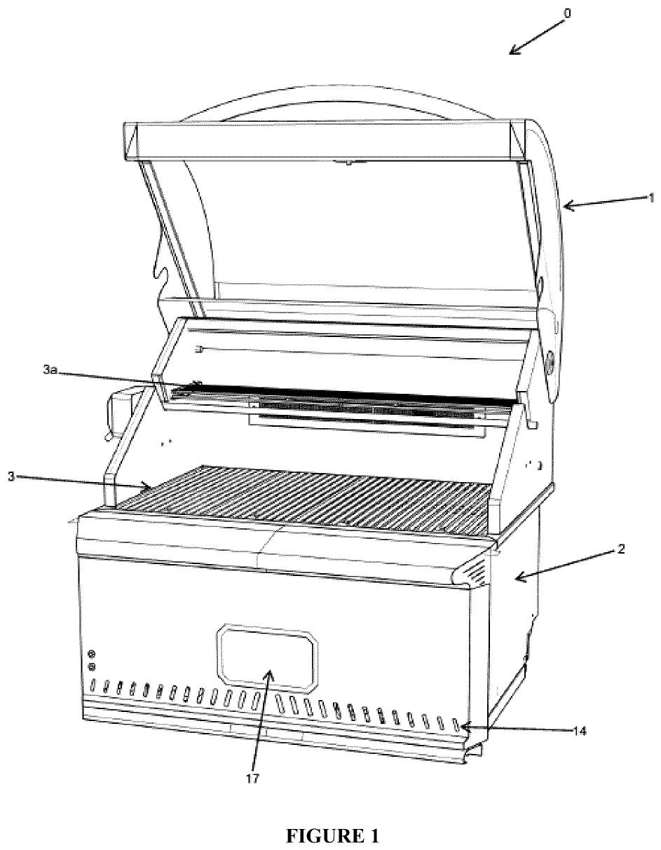

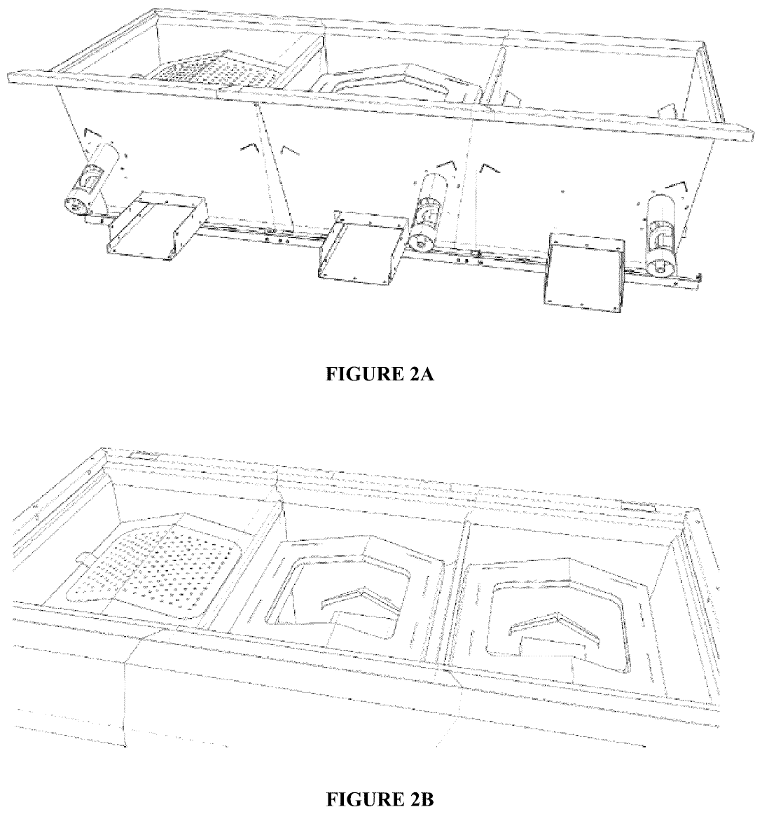

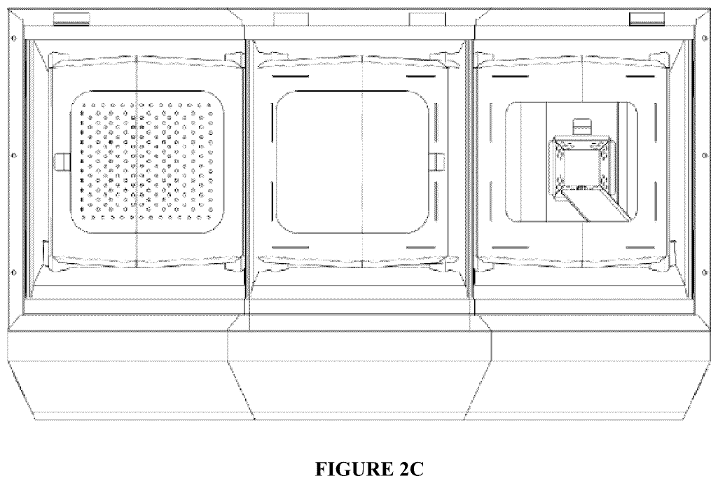

The inventive grill comprises at least two independent fire pots, augers, and therefore, cooking zones. In one or more embodiments, it may be advantageous to have more than two fire pots, augers, and cooking zones. This may depend on the size of the grill and the user's preference. FIG. 1 shows an exemplary embodiment of two fire pots, augers, and cooking zones and FIGS. 2A, 2B, 2C show an embodiment where there are three fire pots, augers, and cooking zones. More sets of fire pots, augers, and cooking zones are contemplated based on user preference.

The grill uses more complex monitoring and real time calculations to allow the user to control different parts of the grill at two different direct heat temperatures. In one or more embodiments, the grill also comprises two ignitors and hoppers. The use of multiple hoppers and augers also allows the user to introduce different types of pellets in differing ratios to obtain better control of the smoke flavor within the cooking chamber. This configuration also allows for different temperature gradients across the cooking chamber or to create multiple smaller chambers.

In one or more embodiments, the inventive grill comprises structures to allow for rotisserie cooking, which has not been possible on prior art pellet grills.

In one or more embodiments, the augers are designed to prevent jamming of the pellets at a set angle and length to prevent burn back.

One or more embodiments of the pellet grill disclosed herein are designed to address a gap in remote monitoring and control. Control configurations are known in the art for local connection control and external network control through cloud computing technology. However, each of these configurations suffers drawbacks. A local only connection is geographically limited, which can be problematic due to the nature of the cooks the grill is designed to accommodate. Many cooks on pellet grills last for hours; for example, a pork butt may cook for upwards of 10 or more hours. The user would lose the ability to monitor the grilling parameters should the user leave the geographic reach of the connection means during that time. Likewise, many users may not appreciate the potential risks that may arise from a grill (or other combustion cooking device) being configured to start or change temperatures from outside the network.

In one or more embodiments, the grill is operationally configured to broadcast information about the grill or grilling parameters, either to a local area network or beyond. The broadcast may occur continuously or at pre-defined increments, such as every 0 to 60 seconds, every 1-1.5 minutes, every 1-2 minutes, every 1-5 minutes, every 1-10 minutes, etc., or whenever a gradient change of the grilling parameters is noticed by onboard sensors. Such gradient changes may also be pre-determined or set by the user. The grill or grilling parameters may be selected from a group comprising ambient temperature, fire pot temperature, fire box temperature, temperature at or near the grill grate, food probe temperature, time of cook, fan speed, pellet feed rate, pellet quantity, and other desired cooking parameters. In various embodiments, the grill may be connected to the network via wired or wireless connection means and may operate through an intermediary such as a router, gateway, switch, or other known device. In such an embodiment, one or more devices on the local area network may access the information broadcast from the grill.

In other embodiments, the grill may be connected to the Internet and configured to broadcast one or more grilling parameters on the internet such that a remote device may monitor those parameters. In some embodiments, the grill may be configured to accept instructions from a device external to the grill, and such device may be connected to the grill via one or more networks. In some embodiments, instructions may cause the grill to change its operating parameters, such as to increase or decrease temperature or smoke. In one or more embodiments, the instructions may dictate the action of the grill, while in other embodiments, the instructions may comprise information which the on-board controller may interpret to take action to achieve. For example, the user may indicate that the user wants the temperature to be 225 degrees Fahrenheit. The user may enter the desired temperature on the remote device which transmits this information to the grill's onboard control unit, which interprets the information and determines how to achieve that temperature—whether to increase or decrease based on the current temperature.

It may be advantageous in one or more embodiments that the grill be configured such that active grilling instructions cannot be sent from outside the local area connection. In such embodiments, the grill may be able to accept instructions through local means such as direct connection via Bluetooth, IR, or other known connection means or by operating on the same local area network as the device from which the instructions originate. In such embodiments, the grill may be configured to accept control instructions from a device so connected to the grill, such instructions selected from a list comprising: setting a timer for cooking, igniting one or more fire pots, controlling the fan to increase or decrease temperature and/or smoke levels, opening or closing dampers to adjust temperature or smoke levels, setting cooking parameters, setting internal temperature alarms, setting a desired temperature, and shutting off the grill.

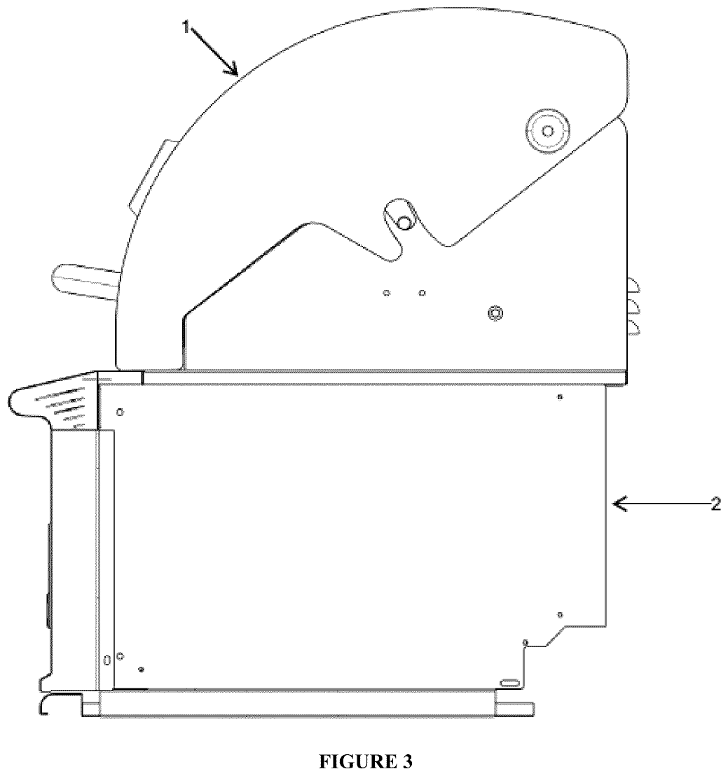

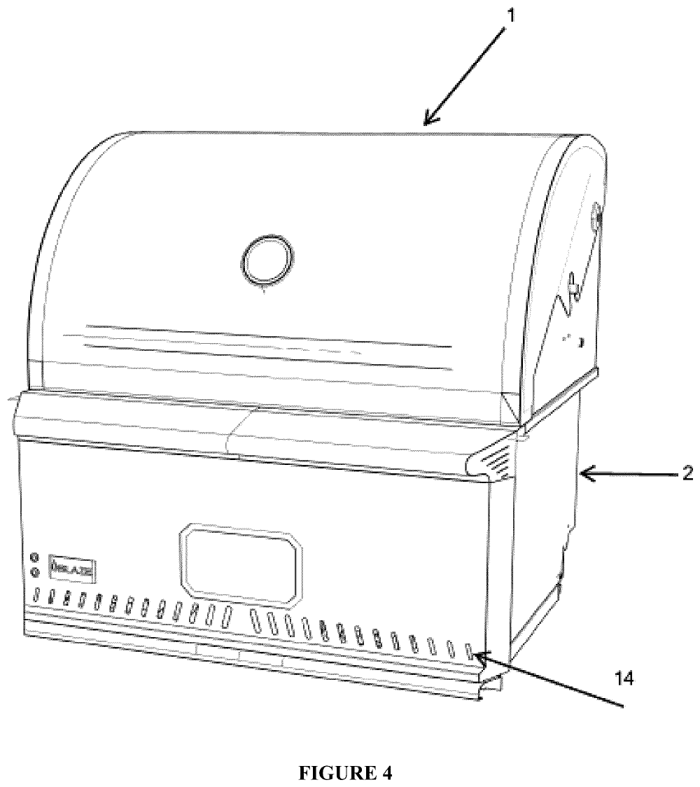

As shown in FIG. 1, FIG. 3, and FIG. 4 the exterior of the grill 0 comprises a quarter-dome shaped hood 1, cooking chamber (or fire box) 2, and at least one grill grate surface 3. As shown in FIG. 1, there may be multiple grilling grates 3a, which may be placed in various configurations and locations depending on the desired use. The cooking chamber 2 may comprises vents 14 preferably placed along the bottom perimeter in the front of the grill 0. However, other vent placements are contemplated, such as on the back or sides. The cooking chamber 2 is sized to accommodate the inner components of the grill and to the user's preference for grill space. For instance, the cooking chamber 2 may be larger to accommodate a larger grill surface 3, 3a or smaller for a more compact application. In one ore more embodiments, the cooking chamber is 32 to 40 inches in length and 18 to 20 inches in depth.

The hood 1 is shown as a quarter-dome shape. However, any shape that provides sufficient heat deflection and space between the grill grates 3, 3a and the hood is contemplated. The hood 1 is also designed so as to form an at least partial seal when closed to keep heat and smoke trapped within the grill. The hood 1 also comprises a handle and, in some embodiments, comprises a temperature gauge. The hood 1 is preferably attached to the cooking chamber 2 through a hinge connection. However, a removable hood 1 is also contemplated. Other connections as known in the art are contemplated such as a friction fit, gasket, or other suitable connections.

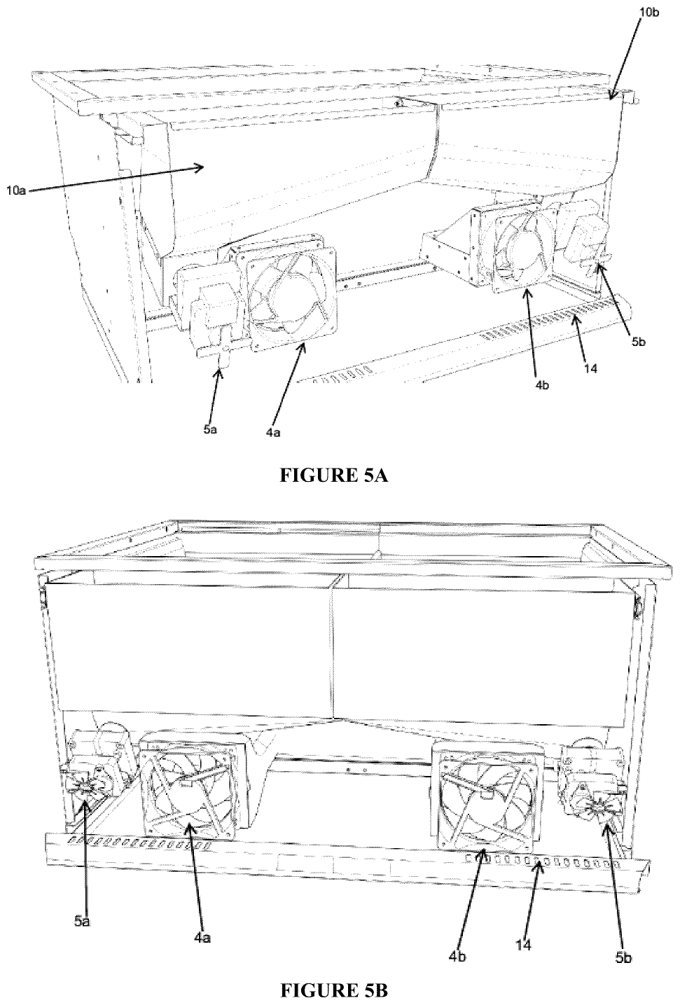

FIG. 5A and FIG. 5B show an internal view of the components within the cooking chamber 2, including augers 4a, 4b and fans 5a, 5b. In one or more embodiments, the grill 0 comprises two of each, fan 5a, 5b and augers 4a, 4b, in order to allow heat and smoke differential across the two sides of the grill 0. The augers 4a, 4b are spiral shaped tools that move the pellets from the hopper (e.g., 10a) to the firebox so that they eventually fall into the fire pots for burning. In one or more embodiments, the augers comprise a helical shaft or part. The augers may be made of aluminum and are approximately 15-25 inches in length and 2-5 inches in diameter, depending on the size of the grill 0.

To prevent pellet jams and ensure consistent pellet feed, in one or more embodiments, the grill features at least one vertical drive auger. This design minimizes the chances of jams, ensuring uninterrupted cooking sessions. The grill's compact auger design, measuring only six inches in length, minimizes the resistance of pellets during transport from the hopper to the firepots. This efficient pellet transport system guarantees a reliable delivery of pellets to the firepot minimizing the ability to receive auger jams

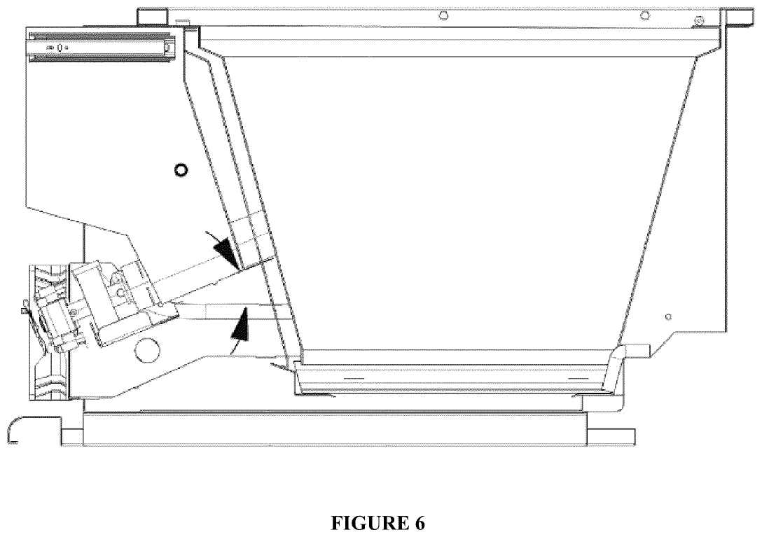

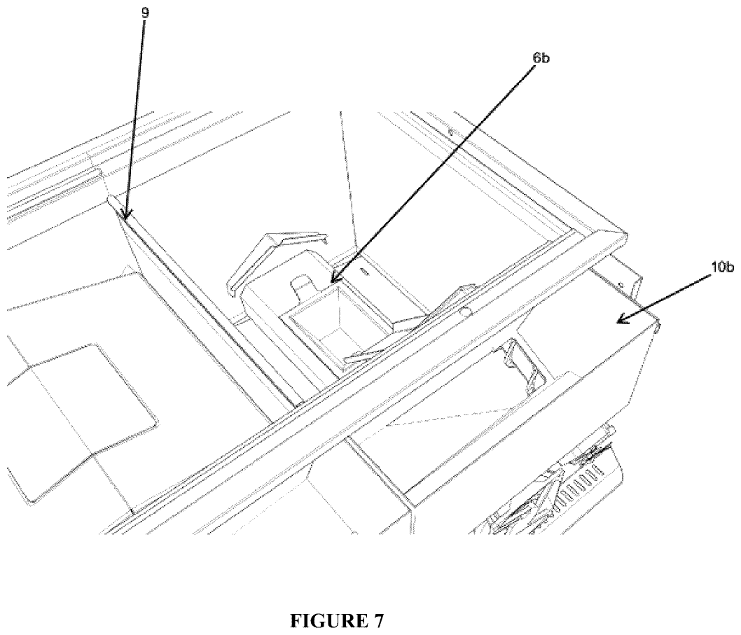

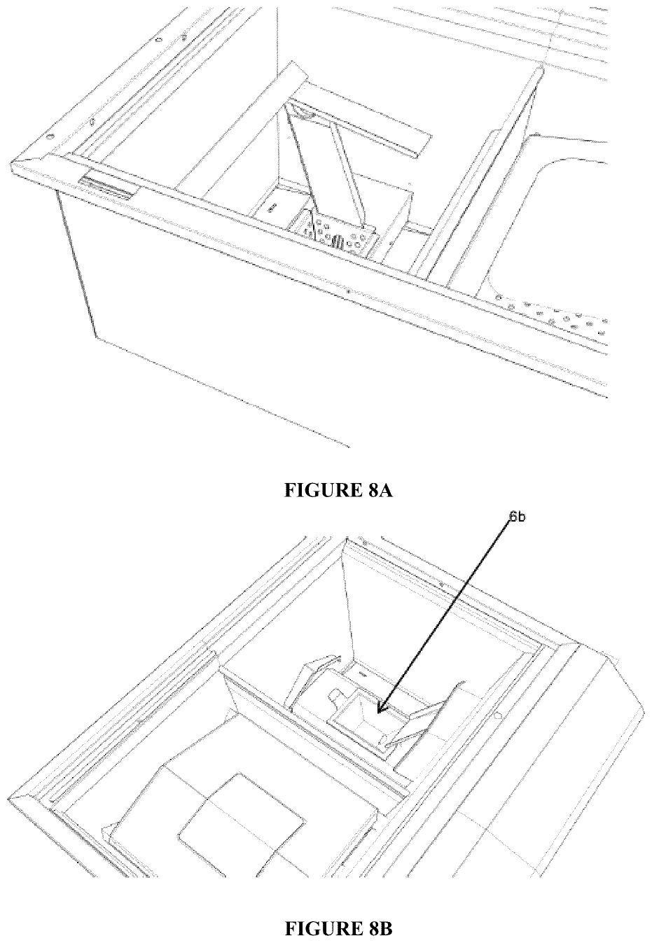

FIG. 6 is a side view of the grill 0 which shows the design of the augers 4a, 4b and the auger angle. The angle is indicated by black, curved arrows. The augers 4a, 4b are angled up, toward the fire box 2, rather than horizontally or downwardly. That way, the pellets are fed into the fire box 2 (shown in FIG. 7) and slide into the fire pots 6a, 6b. In one or more embodiments, the auger angle is 23 degrees from horizontal and is six inches in length. In other embodiments, the auger angle is between 15 and 45 degrees and the length of the auger(s) is 15 inches or less.

In one or more embodiments, each additional fire pot adds approximately 15 inches to the length of the grill 0. That is, from the center of a fire pot to the side of the cooking chamber may be between 10 and 16 inches.

In one or more embodiments, the augers are removably attached for easy cleaning and access. For instance, the augers may be attached with screws, friction fit, or any other suitable means as known in the art.

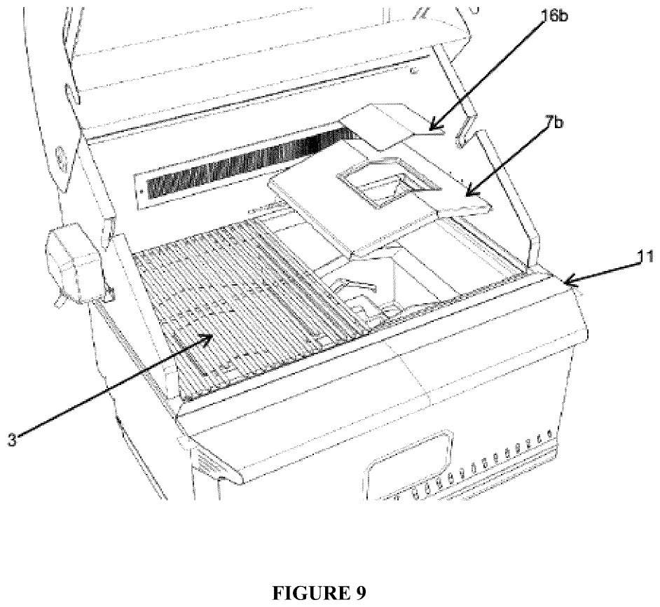

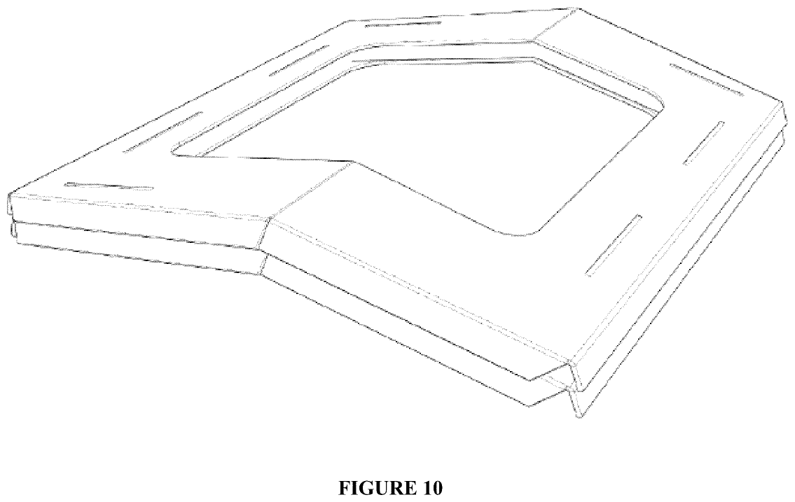

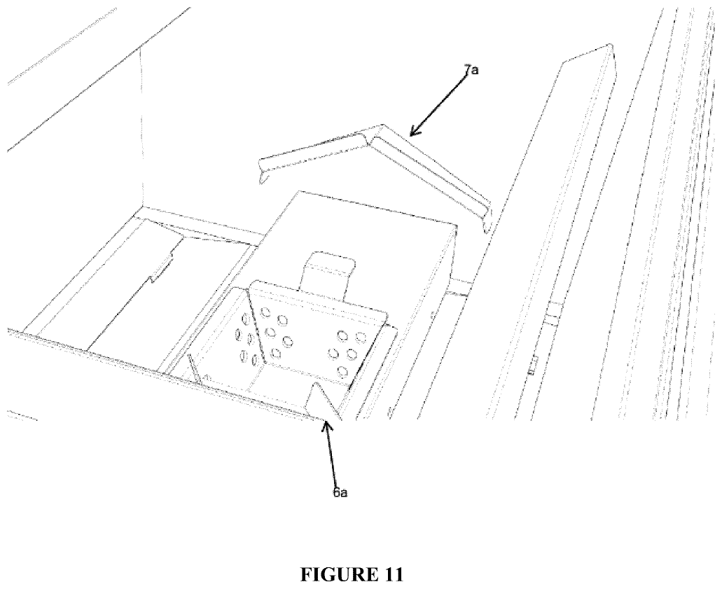

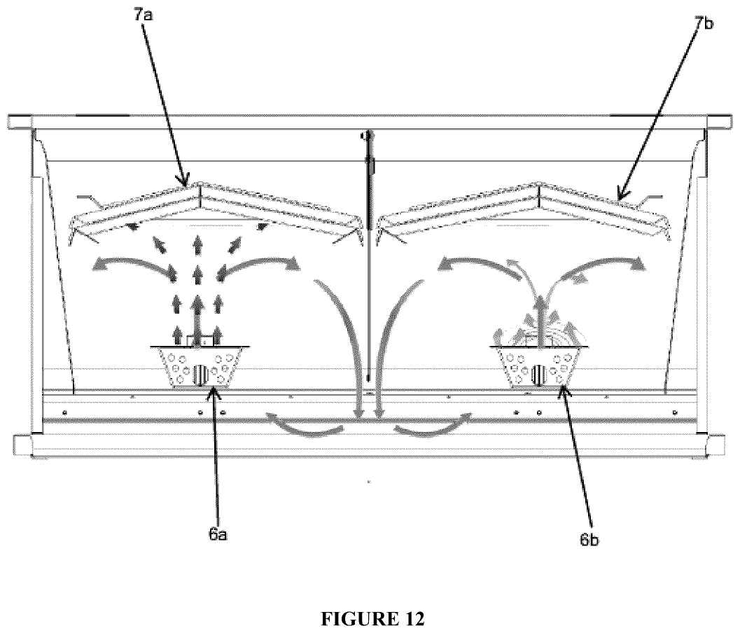

FIG. 9, FIG. 10, FIG. 11, and FIG. 12 show various embodiments of the fire pots 6a, 6b along with diverter plates 7a, 7b. In one or more embodiments, the diverter plates are interchangeable cooking diffusers placed above the fire pots 6a, 6b. These diverter plates may play a role in heat dispersion and indirect cooking. In one or more embodiments, a user may swap diverter plates based on size to adapt the grill's cooking style to their specific needs, whether it's smoking, roasting, or direct grilling. As illustrated by FIG. 12, the diverter plates 7a, 7b are used to direct heat from the fire pots 6a, 6b to the grates 3. As shown in FIG. 9 and FIG. 10, the diverter plates 7a, 7b may be an angled plate with out without a cut out and inner piece 16. In one or more embodiments, the diverter plates are angled upwards to form an upside down v-shape.

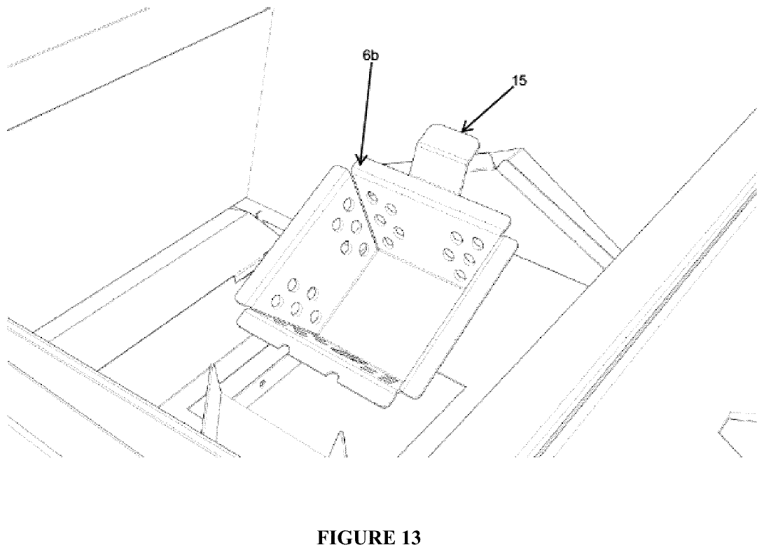

In one or more embodiments, the fire pots 6a, 6b comprise ventilation holes as shown in FIG. 13. In one or more embodiments, the fire pots may be removable for ease of maintenance. This also assists in preventing back burn, enhancing safety and longevity of the grill. In this embodiment, the fire pots may be “slide-in”. FIG. 13 shows one embodiment where the fire pots 6a, 6b comprise a tab 15 for easy removal.

The fans 5a, 5b (FIG. 5A, FIG. 5B) circulate air within the cooking chamber and supply oxygen to the fire pots 6a, 6b. The fan blades may be made of a suitable metal or high temperature rated plastic. FIG. 5A and FIG. 5B also shows the positioning of the augers 4a, 4b, fans 5a, 5b, and vents 14. As shown, vents 14 are placed along the bottom of the cooking chamber 2 in order to allow the fans 5a, 5b to draft ambient air. However, the vents 14 may be placed in other positions on the cooking chamber 2 so long as the fans 5a, 5b maintain the ability to draft ambient air.

Additionally, as shown in FIG. 6, air gaps 13 between the bottom of the cooking chamber 2 and grill outer base 12 allow for additional draft air for the fans 5a, 5b and provide cooling for the hoppers 10a, 10b and other electronics associated with grill 0 controls.

In one or more embodiments, the grill incorporates a comprehensive grease management system, including multiple covers and channels, to prevent grease contact with the firepots. This not only enhances safety by reducing the risk of flare-ups but also simplifies cleanup for users.

Turning to FIG. 7, the grill hood 1 is open and grill grate 3 is removed to show pellet loading and the divide 9. The hopper lid 11 is slid open to show a front hopper 10b. The hopper lid 11 is designed so as to slide open to receive pellets and to slide shut during cooking. In one or more embodiments, the hopper lid fits within a channel on a base piece attached to the front of the grill 0 so that the hopper lid 11 moves longitudinally when acted upon.

In one or more embodiments, opening the lid 11 alters the pellet feed from the hopper to the fire pots. For instance, once the cooking chamber 2 is opened, heat escapes the grill. A controller (discussed in more detail below) may react to the heat fluctuation by pausing the distribution of the pellets from the hoppers 10a, 10b to the augers. In one or more embodiments, the hoppers 10a, 10b comprise no flat area. Instead, the walls and bottoms of the hoppers 10a, 10b are angled to directly feed the fire pots.

The divide 9 forms a barrier between the left and right side of the cooking chamber 2. This allows the user to control separately the direct heat on either side of the grill 0 because the divide 9 acts as a thermal insulator. Each side of the grill comprises its own auger 4a, 4b, fan 5a, 5b, hopper 10a, 10b, and firepot 6a, 6b. The divide 9 may be made of any suitable material to prevent or minimize heat transfer between the two sides, for example, stainless steel.

In one or more embodiments, the divide 9 extends through the top of the grill grates 3. In addition to providing further thermal insulation, the divide 9 prevents or minimizes smoke generated through the burning of the pellets from entering one or the other sides of the grill 0. This allows the user to control the level of smoke and temperature applied on each side of the grill 0 separately while reducing the bleed from one portion to the other. Ideally, the divide 9 is removable such that the user can open up the grilling space to become a large cooking zone of substantially homogenized temperature and smoke. In one or more embodiments, the divide is situated in a groove, channel, or slot.

In one or more embodiments, the grill 0 also comprises lights to illuminate the cooking area. This allows the user to use the grill even when external light may be dim. In one embodiment, the lights are halogen lights. In this embodiment, there may be two lights at 5-10 W, 12V AC. The user may activate the lights through a switch on the grill, through the app discussed below, or the lights may be activated automatically when the grill hood 2 is opened.

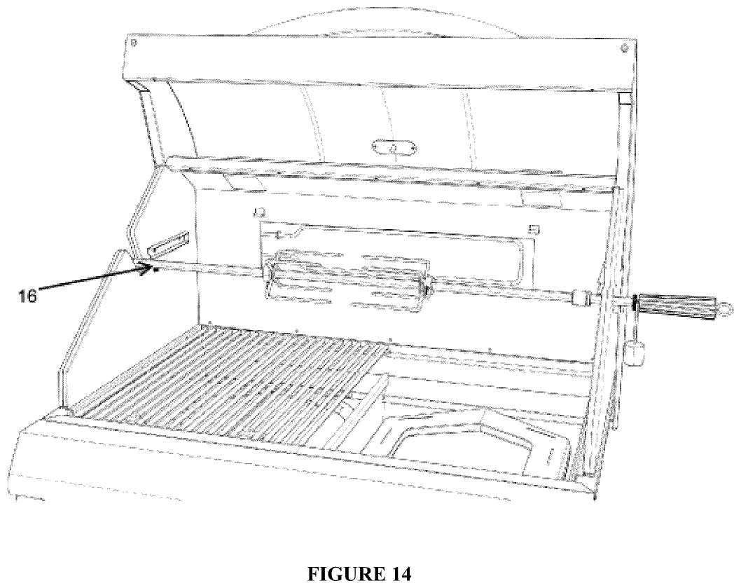

In one or more embodiments, the grill also comprises a rotisserie function. As shown in FIG. 14, the rotisserie spit 16 is built into the hood 2 of the grill. In one or more embodiments, an external heating element is used for rotisserie cooking. In one embodiment, the rotisserie heating element is powered through the grill electronics rather than a separate plug-in. Notches built into the hood allow for the rotisserie heating element to be removably fitted into the grill.

FIG. 1 shows one embodiment of the control board 17. In this embodiment, the control board 17 comprises a touch screen. The control board 17 may be either manually controlled via the on-grill control board 17 or the control board 17 may be connected through Wi-Fi to a remote device, such as a smart phone or other personal electronic device with an app.

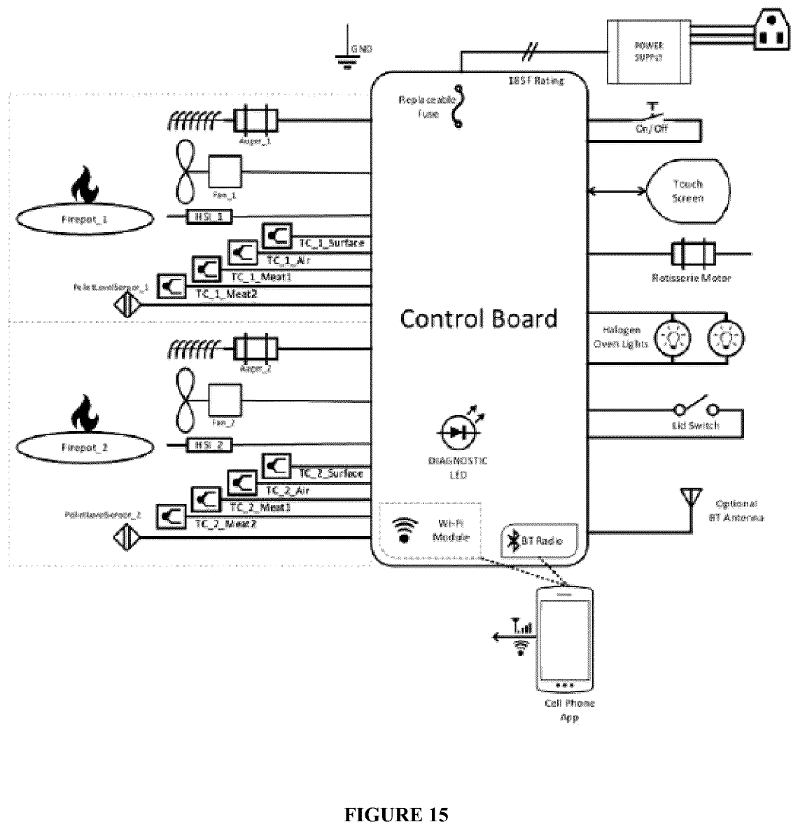

As shown in FIG. 15, the on-grill control board linked to an electronic device through an app. As shown, the grill is powered through a 120V AC plug using a standard 3-prong plug. The control board this embodiment is a single control board for both sides of the grill. This simplifies the electronic communications needed and allows the control logic to be built into a single microprocessor. As part of the on-grill control, sensors provide information on various thermocouple inputs. One such input is the on-surface temperature monitored at the edge of each side of the grill, which can then be extrapolated for the temperature at the center of each side of the grill. The air temperature within the grill is also measured along with the level of pellets (to alert the user to low-pellet levels). In one or more embodiments, meat sensors may also be used to track the temperature of the food grilling. These inputs are processed by the on-grill control board, which then sends signals to the hot surface igniters, fans, and augers for control of those functions.

The control board may be configured to operate each fire pot independently of the other or concurrently in order to substantially homogenize the temperate across the cooking chamber.

In one or more embodiments, a PID algorithm is used. The PID algorithm may be used with a pellet grill or with a gas grill or combination. In one or more embodiments, the PI algorithm comprises three parameters or “gains” that fine-tune the algorithm's response and achieve stable and accurate control of the system. In one or more embodiments, one of the parameters is the proportional gain (Kp) (determines how much the control output responds to the current error (the difference between the desired setpoint and the actual measurement)). A higher Kp value results in a stronger and quicker response to errors, but it may also lead to overshooting and oscillations around the setpoint. A lower Kp may result in slow and insufficient correction of errors. One other parameter may be integral gain (Ki). The integral gain accounts for the cumulative sum of past errors over time. It supports elimination of steady-state errors and corrects for any long-term discrepancies between the setpoint and the actual value. A higher Ki value increases the control system's ability to eliminate steady-state errors, but excessive values can lead to instability and overshooting. In instances were the grill is a gas grill, Ki is essential for addressing biases in the control system, such as small gas leaks or minor inefficiencies. One other parameter may be derivative gain (Kd). The derivative gain anticipates the future trend of the error by calculating its rate of change. It helps dampen oscillations and prevent overshooting by slowing down the control system's response as the error approaches zero. Each of these gains allow the grill to cook more efficiently and at a stabilized temperature.

In one or more embodiments, the PID may comprise altitude compensation. To create a temperature modulation system for a gas grill or pellet grill and allow the controller to read and react to temperature changes effectively and compensate for altitude, a plurality of sensors are required. Thus, in one or more embodiments the following sensors may be integrated in the grill 0 or as modular ad-ons: temperature sensor, flame sensor, and pressure sensor. Temperature sensors monitor the cooking chamber 2 temperature. Any suitable temperature sensor as known in the art may be used. In one or more embodiments, a thermocouple is used as the temperature sensor. In one or more embodiments where a gas grill is used, a flame sensor is provided to ensure safety and control. It detects the presence or absence of a flame in the fire pots. If the flame goes out unexpectedly, the system can respond by shutting off the gas supply to prevent gas leaks.

In one or more embodiments, the temperature sensor comprises multiple sensor locations, such as the grate, hood, and one or more fire pots. This allows the temperature sensor to calculate an average temperature across each of these surfaces. In one or more embodiments, it may be advantageous to weight each of the plurality of sensors differently such that, for example, the read at the fire pots causes the system to react in a stronger manner than a read at the hood. This allows the system to react to temperature changes at the fire pot or grate rather than the temperature at the hood, which may be inflated based on the elevation above the other components. In one or more embodiments, it may also be advantageous for the PID to ignore outlier temperatures. This could occur based on the location or the sensor or, for instance, a grease drip.

In one or more embodiments, a pressure sensor to determine barometric pressure may be used to assist grilling at various altitudes. Increased altitude affects air pressure and therefore, combustion performance. Thus, a pressure sensor is used to compensate for the change in air pressure at higher altitudes. In one or more embodiments, an oxygen sensor may also be used for the same purposes either alone or in connection with the pressure sensor. Based on the sensor readings, further oxygen can be introduced in the cooking chamber.

In one or more embodiments, at least one proximity sensor is used to detect when someone is near the grill. The sensor actuation may trigger display illumination or provide an additional safety feature. For instance, the interface could be directed to lock allowing user control without a code or unlock pattern.

In one or more embodiments, other sensors used to enhance cooking, such as a humidity sensor is used. A humidity sensor would be particularly advantageous when smoking meats.

For the purpose of understanding the Zoned Pellet Grill, references are made in the text to exemplary embodiments of the Zoned Pellet Grill only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

1. A pellet grill comprising:
a. a hood connected to a cooking chamber and at least one grilling grate located at the top of said cooking chamber;
b. at least two augers located on opposing sides of said cooking chamber and in connection with at least one hopper;
c. at least two fans located on opposing sides of said cooking chamber such that said at least two fans provide ambient air to at least two fire pots;
wherein said at least one hopper receives pellets which are fed to each of said at least two fire pots by said at least two augers.

2. The pellet grill of claim 1 further comprising an on-grill control that automatically adjust the temperature and smoke production of the grill based on user inputs.

3. The pellet grill of claim 2 wherein said on-grill control is electronically connected to a personal user device with an app.

4. The pellet grill of claim 1 wherein said cooking chamber is between 32 and 40 inches long.

5. The pellet grill of claim 1 further comprising a rotisserie cooking apparatus.

6. The pellet grill of claim 1 wherein said augers are angled upwards so that pellets are dropped into said fire pots.

7. The pellet grill of claim 1 wherein said augers are angled up towards said at least two fire pots at an angle between 15 and 45 degrees.

8. The pellet grill of claim 1 wherein said augers are removably attached to said at least one hopper.

9. The pellet grill of claim 1 further comprising at least two diverter plates, one connected to the top of each said at least two fire pots.

10. The pellet grill of claim 9 wherein said diverter plates are angled upwards to form an upside down v-shape over each said at least two fire pots.

11. The pellet grill of claim 1 wherein said fire pots comprise a tab for removal.

12. The pellet grill of claim 1 further comprising a divide that separates said cooking chamber into two sections with one set of said auger, fire pot, and fan on each side of said divide.

13. The pellet grill of claim 1 wherein said hopper comprises a sliding lid.

14. The pellet grill of claim 5 wherein said rotisserie cooking apparatus comprises an external heating means which is powered by the grill.

15. A pellet grill comprising at least two augers connected to at least two cooking chambers wherein said augers are vertical drive augers and angled up towards said cooking chambers.

16. The pellet grill of claim 15 wherein said auger are angled up towards said cooking chambers at an angle between 15 and 45 degrees.

17. A control system for a grill comprising a plurality of sensors that control a heating element of said grill; said plurality of sensors consisting of at last one of the following: a temperature sensor, a flame sensor, and a pressure sensor.

18. The control system of claim 17 further comprising an altitude compensation system wherein said pressure sensor is used to compensate for change in air pressure at higher altitudes and an oxygen sensor is used to direct said altitude compensation system to provide more oxygen to said grill.

19. The control system of claim 17 further comprising a humidity sensor.
